(19) United States
(12) Patent Application Publication
(10) Pub. No.: US 2003/0095543 A1
(43) Pub. Date: May 22, 2003

(54) DSL relay method and the apparatus

(76) Inventor: Masakazu Oi, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/100,968

(22) Filed: Mar. 19, 2002

(30) Foreign Application Priority Data
Nov. 16, 2001 (JP) 2001-352420

(51) Int. Cl. H04L 12/66

(52) U.S. Cl. 370/352

(57) ABSTRACT

A DSL relay method is provided, in which the method includes the steps of: converting a DSL signal output from an intra-office conversion part into a first asynchronous transfer mode signal by using an intra-terminal conversion function which is the same as that of an intra-terminal conversion part; converting a DSL signal output from the intra-terminal conversion part into a second asynchronous transfer mode signal by using an intra-office conversion function which is the same as that of the intra-office conversion part; and converting interfaces between the intra-terminal conversion function and. the intra-office conversion function.

### BACKGROUND OF THE INVENTION

1. Field of the Invention

The present invention relates to a DSL relay method and the apparatus. More particularly, the present invention relates to a DSL relay method and the apparatus for relaying DSL (Digital Subscriber Circuits) communications which connects between a terminal (including a user) and a center by using a telephone circuit.

2. Description of the Related Art

There are ADSL (Asymmetric DSL), HDSL (High-bit-rate DSL), SDSL (Symmetric DSL) and VDSL (Very-high-bit-rate DSL) and the like as an xDSL communication technology which uses the telephone circuit using twisted pair wire.

The xDSL communication increases transmission speed by performing DMT (Discrete Multi Tone) modulation by using frequency band equal to or higher than a voice band. For example, ADSL realizes asymmetrical communication by separating frequencies between upstream/downstream. SDSL shares a frequency band for upstream/downstream and uses the frequency band alternately by performing time division communication.

In the following, ADSL which is widely used as the xDSL will be described in detail. ADSL uses frequency bands shown in FIGS. 1A and 1B which are defined in an ITU-T recommendation in which transmission speeds of-upstream/downstream are asymmetrical. In a standard G.992.2 shown in FIG. 1B, the maximum frequency is 552 kHz, and in a standard G.992.1 shown in FIG. 1A, the maximum frequency is 1104 kHz. In addition, large transmission rate can not be used for long distance transmission due to frequency characteristics of subscriber circuits in which transmission loss increases as the frequency increases. Further, transmission distance is limited to about 4 km generally.

Almost every user who uses a telephone service by using a subscriber circuit resides within 8 km from a telephone office. Thus, there is a problem in that the xDSL service can be provided only to users residing within 4 km from the telephone office due to the transmission distance limitation even when the telephone users wants to use the xDSL service.

In order to provide the xDSL service to a user remote from the telephone office, a DSL relay station which has a function as a telephone office becomes necessary. However, large capital investment is necessary to install DSL relay stations for the limited users. Therefore, there is a problem in that it is difficult to install large DSL relay stations having a function of the telephone office since there is a problem of profitability.

### SUMMARY OF THE INVENTION

An object of the present invention is to provide a DSL relay method and the apparatus by which the DSL transmission distance can be extended by using a simple configuration.

The object can be achieved by a DSL relay method used for relaying DSL communication between a telephone office and a terminal, said DSL relay method including the steps of:

converting a DSL signal output from an intra-office conversion part which performs data conversion between asynchronous transfer mode and DSL into a first asynchronous transfer mode signal by using an intra-terminal conversion function which is the same as that of an intra-terminal conversion part which performs data conversion between asynchronous transfer mode and DSL in the terminal;

converting a DSL signal output from the intra-terminal conversion part into a second asynchronous transfer mode signal by using an intra-office conversion function which is the same as that of the intra-office conversion part; and

converting interfaces between the intra-terminal conversion function and the intra-office conversion function by converting the first asynchronous transfer mode signal and the second asynchronous transfer mode signal.

According to the invention, DSL communication can be relayed by a simple configuration, and the DSL transmission distance can be extended.

### BRIEF DESCRIPTION OF THE DRAWINGS

Other objects, features and advantages of the present invention will become more apparent from the following detailed description when read in conjunction with the accompanying drawings, in which:

FIGS. 1A and 1B are figures for explaining frequency bands of ADSL which are defined in an ITU-T recommendation;

FIG. 2 shows a block diagram of a system of an ADSL system reference model;

FIG. 3 shows a block diagram of an embodiment of an ATU-C and an ATU-R;

FIG. 4 is a block diagram of a first embodiment of a relay apparatus of the present invention;

FIGS. 5A and 5B show signal frequency spectrum in a telephone circuits connected to the relay apparatus shown in FIG. 4;

FIG. 6 is a figure for explaining a V-C reference point;

FIG. 7 is a figure for explaining a T-R reference point;

FIG. 8 shows a block diagram of an embodiment of a V-C/T-R interface part 56;

FIG. 9 shows a block diagram of a modification of the relay apparatus of the first embodiment of the present invention;

FIG. 10 shows a block diagram of a modification of the relay apparatus of the second embodiment of the present invention;

FIG. 11 shows an example of signal frequency spectrum in lower circuit/higher circuit in the embodiment shown in FIG. 10;

FIGS. 12A and 12B show another example of signal frequency spectrum in lower circuit/higher circuit in the embodiment shown in FIG. 10;

FIGS. 13A and 13B show still another example of signal frequency spectrum in lower circuit/higher circuit in the embodiment shown in FIG. 10.

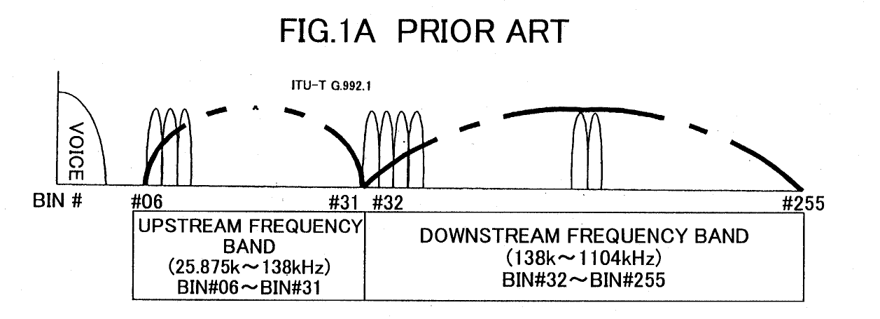

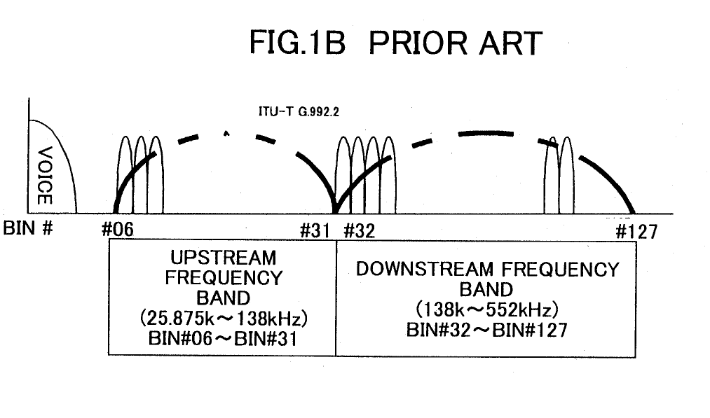

### DETAILED DESCRIPTION OF THE PREFERRED EMBODIMENTS

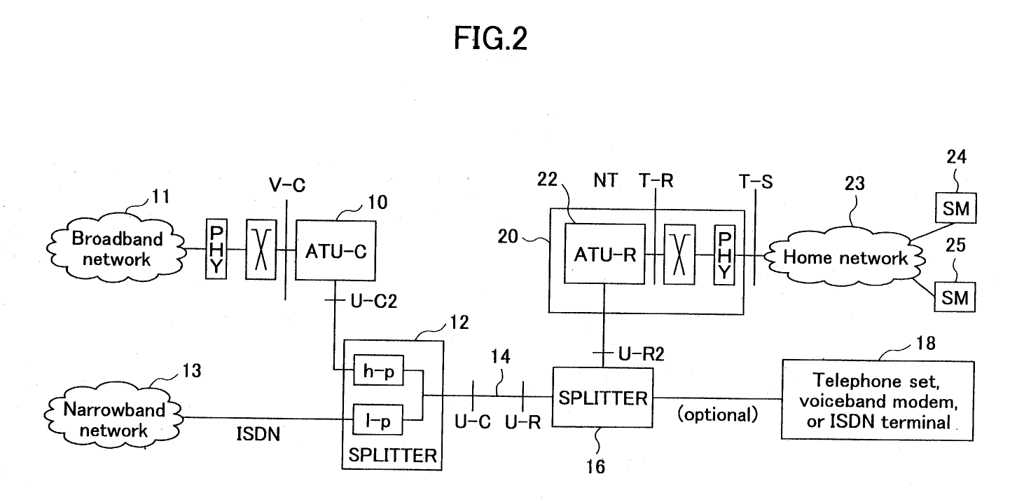

FIG. 2 shows a block diagram of a system of an ADSL system reference model. The ADSL model which will be described includes an apparatus which can perform DSL communication in a user terminal. In the figure, an ATU-C (ADSL Transceiver Unit at the Central office) 10 which performs data conversion between ATM (asynchronous transfer mode) and ADSL in the telephone office is connected to a broadband network from a UTOPIA (Universal Test & Operations Interface For ATM) interface via a V-C reference point, and is connected to a splitter 12 via a U-C2 reference point. In addition, a narrow band network 13 such as ISDN is connected to the splitter 12, and the splitter 12 frequency-multiplexes an ADSL signal output from the ATU-C 10 and an analog signal from the narrow band network 13, outputs the multiplexed signal to a telephone circuit connected to a U-C reference point, and, frequency-demultiplexes the signal from the telephone circuit 14 into signals which are provided to the ATU-C 10 and the narrow band network 13 respectively.

The telephone circuit 14 is connected to a splitter in a house via U-R reference point. A telephone/ISDN terminal 18 and an ADSL modem 20 are connected to the splitter 16. An analog signal generated in the splitter 16 by performing frequency-demultiplexing is provided to the telephone/ISDN terminal 18, and an ADSL signal generated in the splitter 16 by performing frequency-demultiplexing is provided to the ADSL modem 20 via a U-R2 reference point. In addition, signals from the telephone/ISDN terminal 18 and the ADSL modem 20 are frequency-multiplexed and the multiplexed signal is provided to the telephone circuit 14.

The ADSL modem 20 includes an ATU-R (ADSL Transceiver Unit at the Remote terminal) 22, which has the same configuration as the ATU-C 10, which performs data conversion between ATM and ADSL. The ATU-R 22 is connected to a home network 23 from the UTOPIA interface via a T-R reference point, in addition, terminals 24 and 25 are connected to the home network 23.

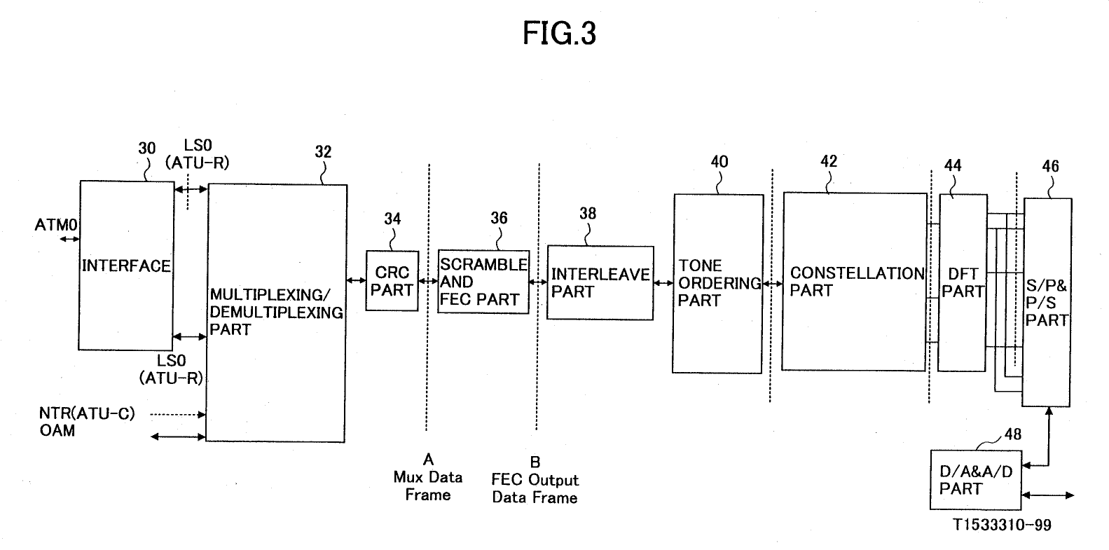

FIG. 3 shows a block diagram of an embodiment of the ATU-C and the ATU-R. In the figure, an ATM interface 30 is connected to the V-C reference point or the T-R reference point, and receives ATM cells. The ATM cells are provided to a multiplexing/demultiplexing part 32, and the ATM cells are converted into ADSL frames to which CRC code is added in a CRC part 34. After that, the ADSL frame is scrambled in a scramble and FEC part 36 and forward error correction code is added to the scrambled data, and the output data is interleaved in an interleave part 38.

After that, tones necessary for transmission are assigned from 256 tones (carriers) at the maximum in a tone ordering part 40, and constellation encoding is performed in a constellation part 42. Then, Discrete Fourier transform is performed in a DFT part 44. After that, the output data is converted into parallel data in an S/P&P/S conversion part 46, and, then, the data is converted into analog data in a D/A&A/D conversion part 48, so that an ADSL signal is output. The D/A&A/D conversion part 48 is connected to the U-C2 reference point or to the U-R2 reference point.

On the other hand, an ADSL signal which is provided to the D/A&A/D conversion part 48 is digitized, and is converted into serial data in the S/P&P/S conversion part 46. Then, inverse discrete Fourier transform is performed in the DFT part 44. After that, constellation decode is performed in the constellation part 42, deinterleave is performed in the interleave part 38 via the tone ordering part 40, and decoding for forward error correction code and descramble are performed in the scramble and FEC part 36. In addition, decoding of CRC code is performed in the CRC part 34, and the data is demultiplexed in the multiplexing/demultiplexing part 32 into ATM cells. After that, the ATM cells are output to the V-C reference point or to the T-R reference point.

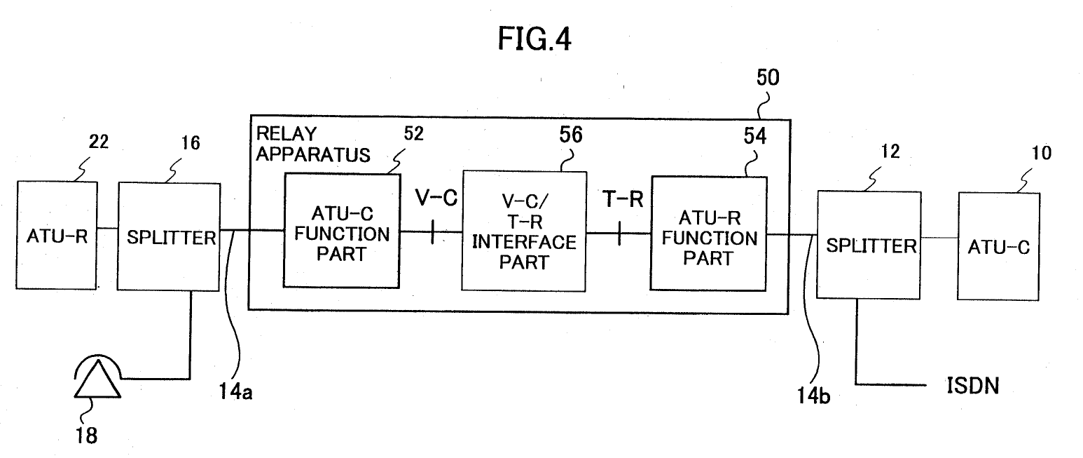

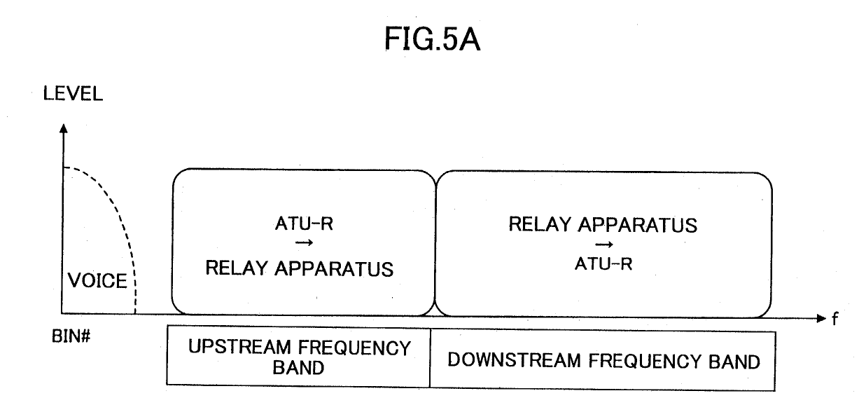

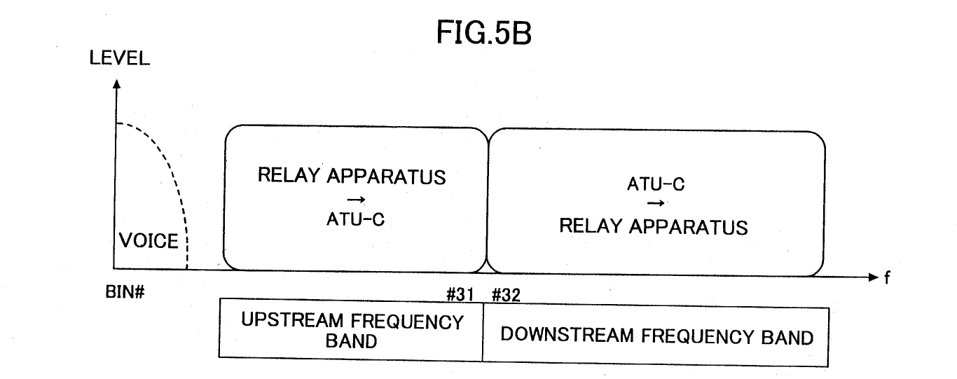

FIG. 4 is a block diagram of a first embodiment of a relay apparatus of the present invention. FIGS. 5A and 5B show signal frequency spectrums in telephone circuits connected to the relay apparatus shown in FIG. 4. In FIG. 4, the same numerals are assigned to the same parts as those shown in FIG. 2. In FIG. 4, the ATU-R 22 is connected to the telephone circuit 14a via the splitter 16, and the ATU-C 10 is connected to the telephone circuit 14b via the splitter 12.

A relay apparatus 50 is provided between the telephone circuits 14a and 14b. The relay apparatus 50 includes an ATU-C function part 52 which is connected to the telephone circuit 14a in a state opposite to the ATU-R 22, an ATU-R function part 54 which is connected to the telephone circuit 14b in a state opposite to the ATU-C 10, and a V-C/T-R interface part 56 which performs interface conversion between the ATU-C function part 52 and the ATU-R function part 54.

The ATU-C function part 52 has the same function as that of the ATU-C 10 and the configuration is shown in FIG. 3. FIG. 5A shows signal frequency spectrum in the telephone circuit 14a (lower circuit) between the splitter 16 and the ATU-C function part 52. The ATU-R function part 54 has the same function as that of the ATU-R 22 and the configuration is shown in FIG. 3. FIG. 5B shows signal frequency spectrum in the telephone circuit 14b (higher circuit) between the splitter 12 and the ATU-R function part 54.

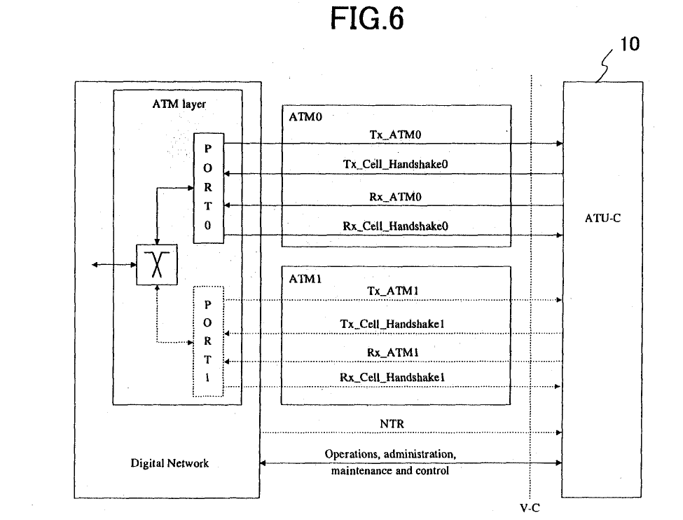

As shown in FIG. 6, the V-C reference point is a point for converting information of ADSL circuit physical layer in the ATU-C 10 into information of ATM layer. In the V-C reference point, downstream cell Tx_ATM0/1, downstream cell handshake response Tx_Cell_Handshake, upstream cell Rx_ATM0/1, upstream cell handshake response Rx_Cell_Handshake, NTR for network timing transferring and operation channel OAM are transferred. ATM0 and ATM1 indicate two different channels, and the part to the left of ATM layer indicates higher order layer.

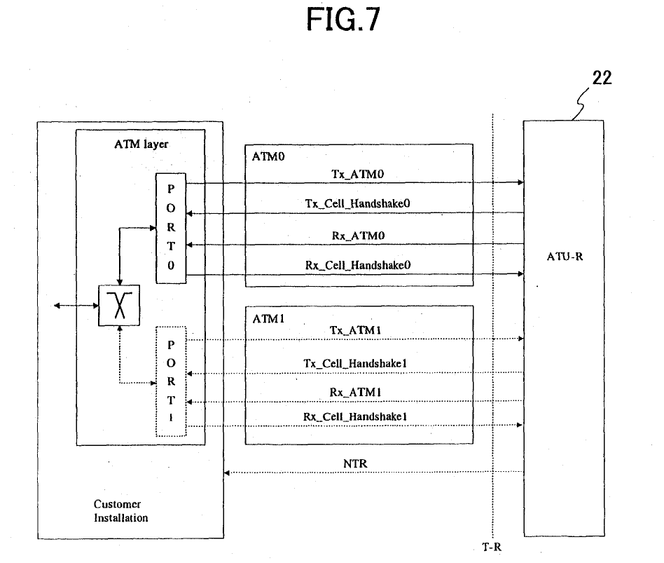

As shown in FIG. 7, the T-R reference point is a point for converting information of ADSL circuit physical layer in the ATU-R 22 into information of ATM layer. In the T-R reference point, upstream cell Tx_ATM0/1, upstream cell handshake response Tx_Cell_Handshake, downstream cell Rx_ATM0/1, downstream cell handshake response Rx_Cell_Handshake, NTR for network timing transferring and operation channel OAM are transferred.

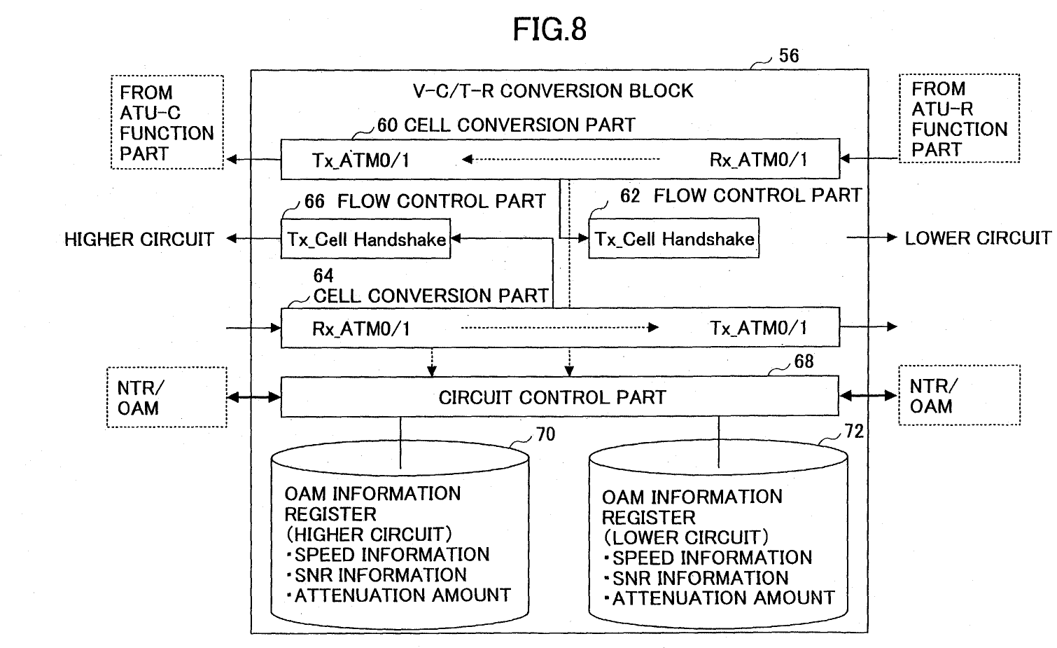

FIG. 8 shows a block diagram of an embodiment of the V-C/T-R interface part 56. In the figure, a cell conversion part 60 converts the cell Rx_ATM0/1 provided from the ATU-R function part 54 into the cell Tx_ATM0/1, and provides the cell Tx_ATM0/1 to the ATU-C function part 52. A flow control part 62 performs flow control by using the downstream cell handshake response Rx_Cell_Handshake in order to avoid cell overflow/underflow for downstream cells.

A cell conversion part 64 converts the cell Rx_ATM0/1 provided from the ATU-C function part 52 into the cell Tx_ATM0/1, and provides the cell Tx_ATM0/1 to the ATU-R function part 54. A flow control part 66 performs flow control by using the upstream cell handshake response Tx_Cell_Handshake in order to avoid cell overflow/underflow for upstream cells.

A circuit control part 68 includes following five-functions for controlling information of upstream/downstream.

1. A function for transferring bits (NTR) for correcting 8 KHz network timing phase of higher network of the ATU-C function part 52 side to the lower ATU-R function part 54 side.

2. A function for writing/reading of circuit information of higher circuit of the ATU-C function part 52 to/from an OAM information register (higher circuit) 70 by using operation channel.

3. A function for writing/reading of circuit information of lower circuit of the ATU-R function part 52 side to/from an OAM information register (lower circuit) 72 by using operation channel.

The circuit information is defined as OAM operation channel, and includes transmission speed information, circuit attenuation, circuit SNR margin and the like for example.

4. A function for instructing the ATU-R function part 54 and the ATU-C function part 54 to adjust to the lower speed in the upstream transmission speed information obtained for the higher circuit and the lower circuit.

5. A function for instructing the ATU-R function part 54 and the ATU-C function part 54 to adjust to the lower speed in the downstream transmission speed information obtained for the higher circuit and the lower circuit.

By using AOC channel for speed adjustment, the number of using carrier bits is increased/decreased.

In this embodiment, each of upstream frequency band and downstream frequency band is the same between the signal frequency spectrum in the lower circuit 14a between the splitter 16 shown in FIG. 5A and the signal frequency spectrum in the higher circuit 14a between the splitter 12 shown in FIG. 5B.

A conventional DSL relay station which has a function of a telephone office has protocol layer higher than ATM layer so that applications for cell switching and communication protocol (TCP/IP,UDP and the like) network become necessary. Thus, circuit configuration is complicated. On the other hand, according to a relay apparatus of the present invention, since the relay apparatus performs only ATM layer relay processing, the circuit configuration becomes simpler. In addition, the conventional DSL relay apparatus becomes a large sized apparatus accommodating a large number of circuits. On the other hand, the size of the relay apparatus of the preset invention is for 1 to several number of circuits, so that the configuration becomes simpler.

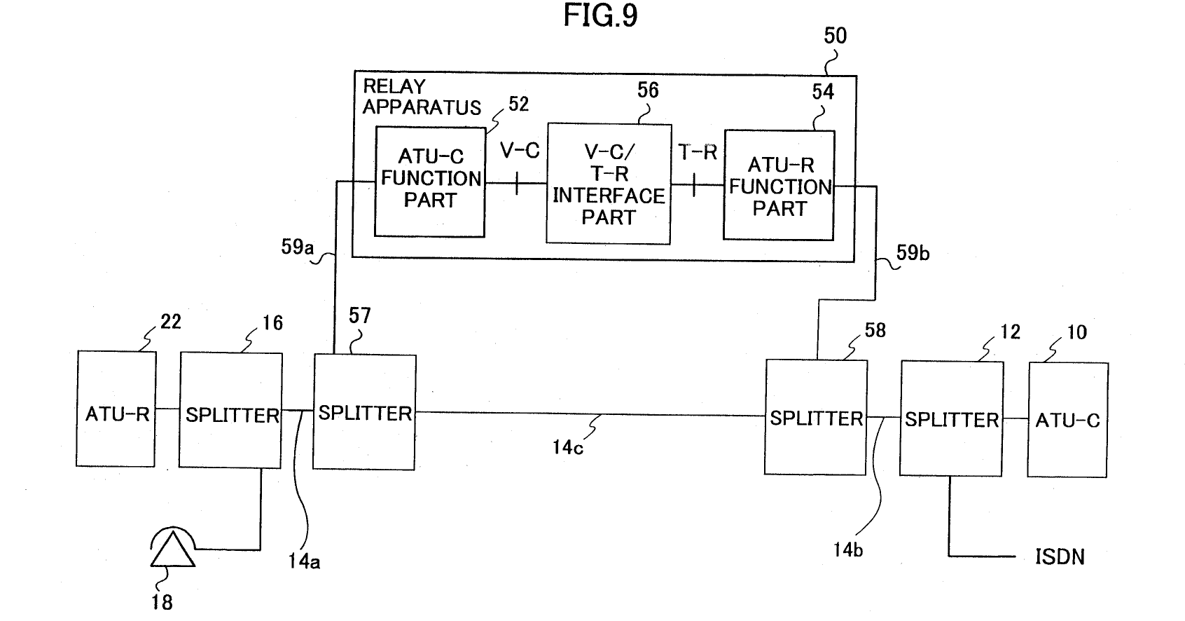

FIG. 9 shows a block diagram of a modification of the first embodiment of the present invention. In this modification, the splitter is connected to the telephone circuit 14a and the splitter 58 is connected to the telephone. circuit 14b, and the splitters 57 and 58 are connected by a telephone circuit 14c. The splitters 57 and 58 send separated voice band to the telephone circuit 14c and separated ADSL-band to the relay apparatus 50 from each of lower circuit 59a and higher circuit 59b. Also in this embodiment, the signal frequency spectrum in the lower circuit 59a is shown in FIG. 5A, and the signal frequency spectrum in the higher circuit 59b is shown in FIG. 5B, in which each of upstream frequency band and downstream frequency band is the same.

Accordingly, in this embodiment, relay of DSL communication can be performed by using the relay apparatus 50 which has a simple configuration including the ATU-C function part 52, the ATU-R function part 54 and the V-C/T-R interface part 56, and the DSL communication distance can be almost doubled. In addition, relay of ADSL communication can be performed without changing conventional ADSL signal band.

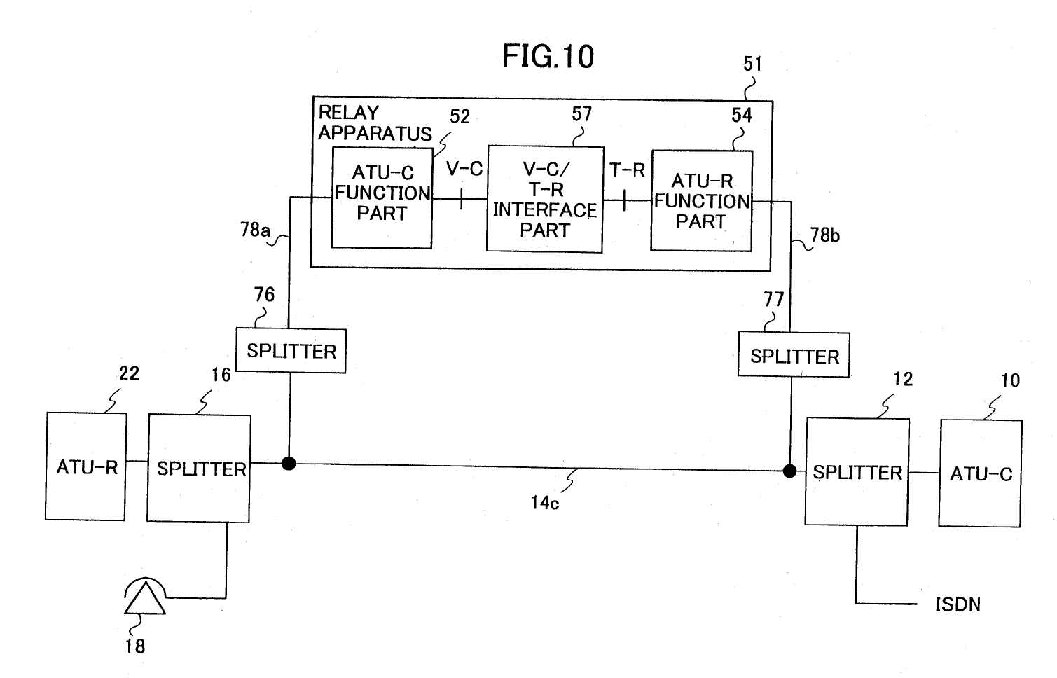

FIG. 10 is a block diagram of a second embodiment of the relay apparatus of the present invention. In FIG. 10, the same numerals are assigned to the same parts as those shown in FIG. 4. In FIG. 10, the ATU-R 22 is connected to the telephone circuit 14c via the splitter 16, and the ATU-C 10 is connected to the telephone circuit 14c via the splitter 12.

Splitters 76, 77 which separate ADSL band are connected to the telephone circuit 14 near the splitters 16 and 12 respectively, and the relay apparatus 51 is connected to the splitters 76 and 77 via the lower circuit 78a and the higher circuit 78b. The relay apparatus 51 includes the ATU-C function part 52 which is connected to the lower circuit 78a in a state opposite to the ATU-R 22, the ATU-R function part 54 which is connected to the higher circuit 78b in a state opposite to the ATU-C 10, and a V-C/T-R interface part 57 which connects the ATU-C function part 52 and the ATU-R function part 54.

The relay apparatus 51 is almost the same configuration as that of the relay apparatus 50 shown in FIG. 8. Following information is added to the circuit control part 68. These items of information are used for dividing frequency bands of tones (carriers) used for upstream direction and used for downstream direction. Since #1˜#255 are allowed for the indexes for tones used in DMT, indexes are assigned to each of the upstream and downstream beforehand. Following is an example for the assignment.

1. #1˜#16 are assigned for frequency bands used for upward communication in the lower circuit from the ATU-R22 to the relay apparatus 51.

2. #17˜#31 are assigned for frequency bands used for upward communication in the higher circuit from the relay apparatus 51 to the ATU-C10.

3. #32˜#127 are assigned for frequency bands used for downward communication in the higher circuit from the ATU-C10 to the relay apparatus 51.

4. #128˜#255 are assigned for frequency bands used for downward communication in the lower circuit from the relay apparatus 51 to the ATU-R22.

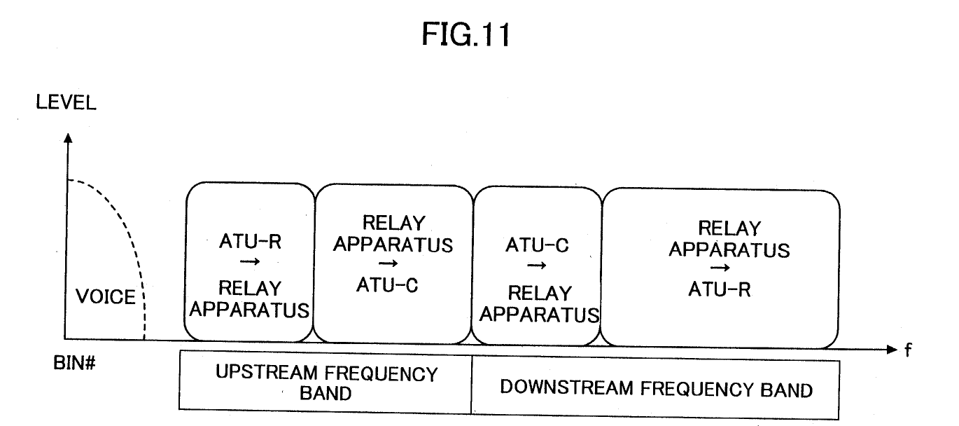

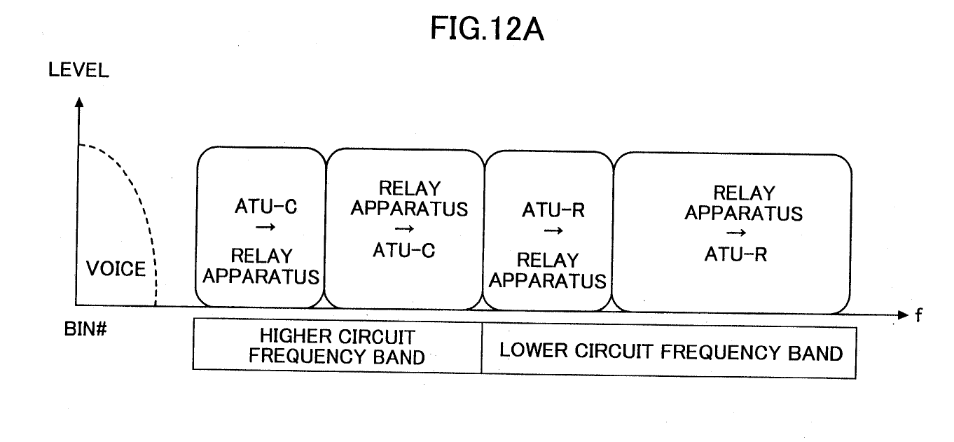

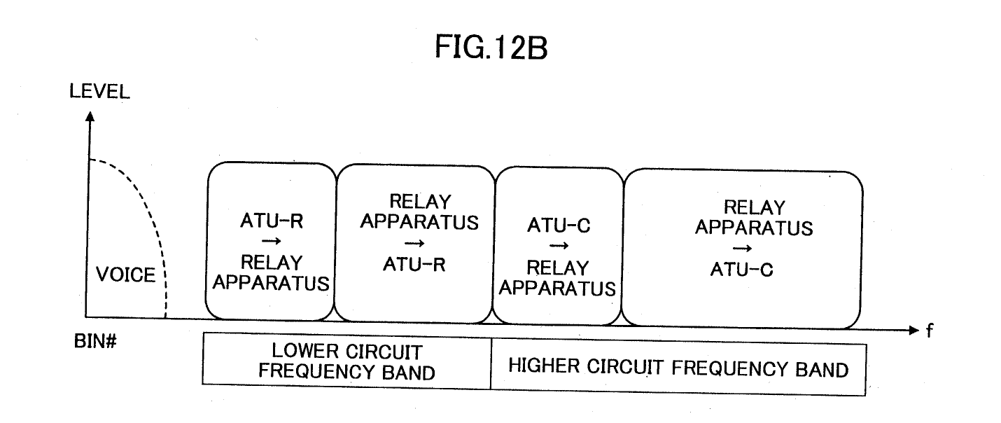

FIG. 11 shows signal frequency spectrum in the lower circuit 78a and the higher circuit 78b in this embodiment. Also, frequency bands can be assigned as shown in FIGS. 12A and 12B.

In addition, the number of tones to be used is assigned before starting communication, and communication is started when the tones the number of which is the same as the assigned number are kept. As a result, transmission speed between the ATU-R22 and the relay apparatus 51 and the transmission speed between the ATU-C10 and the relay apparatus 51 become the same.

In this case, the relay apparatus 51 performs following processing in the circuit control part 68.

1. An interface of the higher circuit 78b between the ATU-C10 and the relay apparatus 51 is disconnected before starting communication.

2. Noise floor of lower circuit 78a between the relay apparatus 51 and the ATU-R22 is measured and the noise floor is stored in the OAM information register (lower circuit) 72.

3. The lower circuit 78a between the relay apparatus 51 and the ATU-R22 is disconnected once, and the higher circuit 78b is connected next.

4. Noise floor of the higher circuit 78b between the relay apparatus 51 and ATU-C10 is measured and the noise floor is stored in the OAM information register (higher circuit) 70.

5. The higher circuit 78b from the relay apparatus 51 to the ATU-C10 is disconnected once.

6. The circuit control part 68 determines tone frequency allocation such that the upstream speeds become the same and determines tone frequency allocation such that the downstream speeds become the same by using each noise floor of the upstream/downstream circuits.

7. Only for the higher circuit, negotiation is performed between the relay apparatus 51 and the ATU-R22 so that tone frequency allocation information used by each other is exchanged by using the register information in the circuit control part. Then, communication is ended once.

8. Only for the lower circuit, negotiation is performed between the relay apparatus 51 and the ATU-C10 so that tone frequency allocation information used by each other is exchanged by using the register information in the circuit control part. Then, communication is ended once.

9. Each of higher/lower circuits is connected, and communication is started by using the tone frequency allocation obtained in previous processes 7 and 8.

In the above processes, the process 8 can be performed before the process 7.

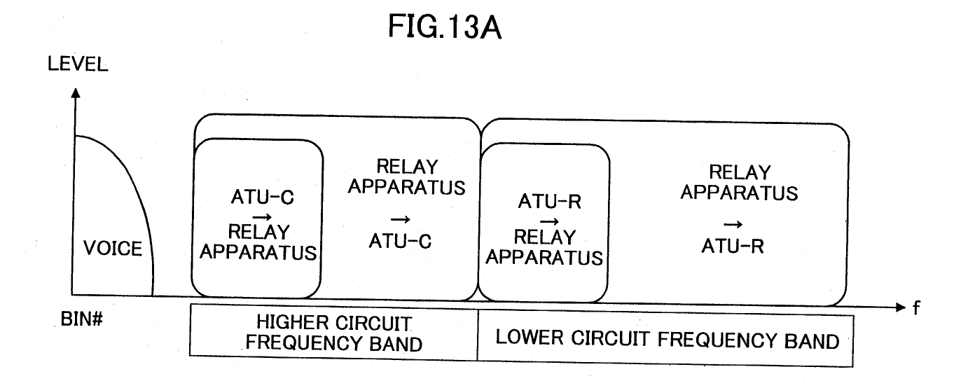

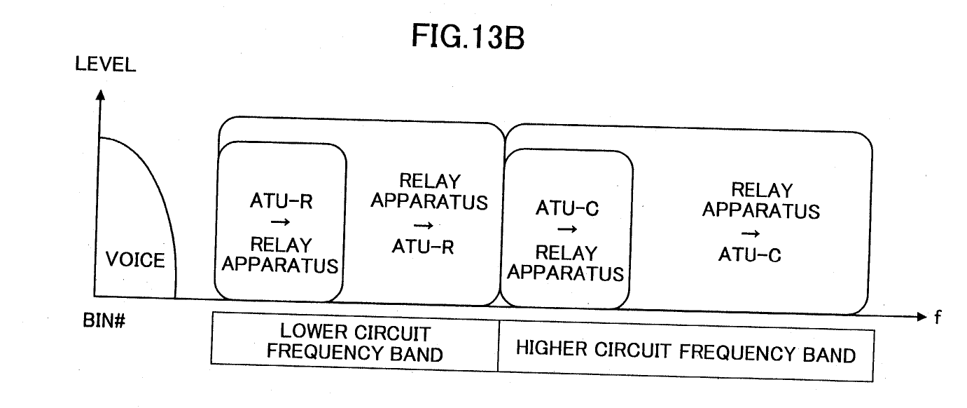

In addition, the ATU-R function part 54 sends a signal by overlapping frequency band with the frequency band sent by the ATU-C10. The ATU-R function part 54 removes the signal sent by itself by using a hybrid circuit and extracts only the signal sent from the ATU-C10. In the same way, the ATU-C function part 52 sends a signal by overlapping frequency band with the frequency band sent by the ATU-R22. The ATU-C function part 52 removes the signal sent by itself by using a hybrid circuit and extracts the signal sent from the ATU-R22. As a result, transmission rate can be improved. FIGS. 13A and 13B show signal frequency spectrums in this case. FIGS. 13A and 13B corresponds to FIGS. 12A and 12B.

The ATU-C10 corresponds to the intra-office conversion part, The ATU-R22 corresponds to the intra-terminal conversion part, the ATU-R function part 54 corresponds to the intra-terminal conversion part, the ATU-C function part 52 corresponds to the intra-office conversion part, and the V-C/T-R interface part 56 corresponds to the interface conversion part.

As mentioned above, the DSL relay apparatus includes: an intra-terminal conversion function part for converting a DSL signal output from an intra-office conversion part which performs data conversion between asynchronous transfer mode and DSL into a first asynchronous transfer mode signal by using an intra-terminal conversion function which is the same as that of an intra-terminal conversion part which performs data conversion between asynchronous transfer mode and DSL in the terminal; an intra-office conversion function part for converting a DSL signal output from the intra-terminal conversion part into a second asynchronous transfer mode signal by using an intra-office conversion function which is the same as that of the intra-office conversion part; and an interface conversion part for converting interfaces between the intra-terminal conversion function part and the intra-office conversion function part by converting the first asynchronous transfer mode signal and the second asynchronous transfer mode signal.

According to the present invention, DSL communication can be relayed by a simple configuration, and the DSL transmission distance can be extended.

In the configuration, the ATU-C10 corresponds to the intra-office conversion part, The ATU-R22 corresponds to the intra-terminal conversion part, the ATU-R function part 54 corresponds to the intra-terminal conversion part, the ATU-C function part 52 corresponds to the intra-office conversion part, and the V-C/T-R interface part 56 corresponds to the interface conversion part.

In addition, according to the present invention, since connection between the intra-terminal conversion function part and the intra-office conversion part and connection between the intra-office conversion function part and the intra-terminal conversion part are independent of each other, DSL communication can be relayed without changing conventional DSL signal band.

In addition, according to the present invention, since signal bands used for an upstream signal and a downstream signal transmitted between the intra-office conversion part and the intra-terminal conversion function part are separated, and signal bands used for an upstream signal and a downstream signal transmitted between the intra-office conversion function part and the intra-terminal conversion part are separated, DSL communication can be relayed even if connection between the intra-terminal conversion function part and the intra-office conversion part and connection between the intra-office conversion function part and the intra-terminal conversion part are not independent.

In addition, according to the present invention, since the interface conversion part allocates the number of tones before starting communication such that transmission speed between the intra-office conversion part and the intra-terminal conversion function part and transmission speed between the intra-office conversion function part and the intra-terminal conversion part become the same, the transmission speed between the intra-office conversion part and the intra-terminal conversion function part can be rendered to be the same as the transmission speed between the intra-office conversion function part and the intra-terminal-conversion part.

The present invention is not limited to the specifically disclosed embodiments, and variations and modifications may be made without departing from the scope of the invention.

What is claimed is:

1. A DSL relay method used for relaying DSL communication between a telephone office and a terminal, said DSL relay method comprising the steps of:
converting a DSL signal output from an intra-office conversion part which performs data conversion between asynchronous transfer mode and DSL into a first asynchronous transfer mode signal by using an intra-terminal conversion function which is the same as that of an intra-terminal conversion part which performs data conversion between asynchronous transfer mode and DSL in said terminal;
converting a DSL signal output from said intra-terminal conversion part into a second asynchronous transfer mode signal by using an intra-office conversion function which is the same as that of said intra-office conversion part; and
converting interfaces between said intra-terminal conversion function and said intra-office conversion function by converting said first asynchronous transfer mode signal and said second asynchronous transfer mode signal.

2. The DSL relay method as claimed in claim 1, wherein connection between said intra-terminal conversion function and said intra-office conversion part and connection between said intra-office conversion function and said intra-terminal conversion part are independent of each other.

3. The DSL relay method as claimed in claim 1, wherein signal bands used for an upstream signal and a downstream signal transmitted between said intra-office conversion part and said intra-terminal conversion function are separated, and signal bands used for an upstream signal and a downstream signal transmitted between said intra-office conversion function and. said intra-terminal conversion part are separated.

4. The DSL relay method as claimed in claim 2, the step of converting interfaces further comprising the step of:
allocating the number of tones before starting communication such that transmission speed between said intra-office conversion part and said intra-terminal conversion function and transmission speed between said intra-office conversion function and said intra-terminal conversion part become the same.

5. The DSL relay method as claimed in claim 3, the step of converting interfaces further comprising the step of:
allocating the number of tones before starting communication such that transmission speed between said intra-office conversion part and said intra-terminal conversion function and transmission speed between said intra-office conversion function and said intra-terminal conversion part become the same.

6. A DSL relay apparatus used for relaying DSL communication between a telephone office and a terminal, said DSL relay apparatus comprising:
an intra-terminal conversion function part for converting a DSL signal output from an intra-office conversion part which performs data conversion between asynchronous transfer mode and DSL into a first asynchronous transfer mode signal by using an intra-terminal conversion function which is the same as that of an intra-terminal conversion part which performs data conversion between asynchronous transfer mode and DSL in said terminal;
an intra-office conversion function part for converting a DSL signal output from said intra-terminal conversion part into a second asynchronous transfer mode signal by using an intra-office conversion function which is the same as that of said intra-office conversion part; and
an interface conversion part for converting interfaces between said intra-terminal conversion function part and said intra-office conversion function part by converting said first asynchronous transfer mode signal and said second asynchronous transfer mode signal.

7. The DSL relay apparatus as claimed in claim 6, wherein connection between. said intra-terminal. conversion function part and said intra-office conversion part and connection between said intra-office conversion function part and said intra-terminal conversion part are independent of each other.

8. The DSL relay apparatus as claimed in claim 6, wherein signal bands used for an upstream signal and a downstream signal transmitted between said intra-office conversion part and said intra-terminal conversion function part are separated, and signal bands used for an upstream signal and a downstream signal transmitted between said intra-office conversion function part and said intra-terminal conversion part are separated.

9. The DSL relay apparatus as claimed in claim 7, wherein said interface conversion part allocates the number of tones before starting communication such that transmission speed between said intra-office conversion part and said intra-terminal conversion function part and transmission speed between said intra-office conversion function part and said intra-terminal conversion part become the same.

10. The DSL relay apparatus as claimed in claim 8, wherein said interface conversion part allocates the number of tones before starting communication such that transmission speed between said intra-office conversion part and said intra-terminal conversion function part and transmission speed between said intra-office conversion function part and said intra-terminal conversion part become the same.
